(19) United States
(12) Patent Application Publication
(10) Pub. No.: US 2016/0159451 A1
(43) Pub. Date: Jun. 9, 2016

(54) BALLOON DESCENT DECELERATOR

(71) Applicant: Raven Industries, Inc., Sioux Falls, SD (US)

(72) Inventor: Randy E. Scott, Sulphur Springs, TX (US)

(21) Appl. No.: 14/958,527

(22) Filed: Dec. 3, 2015

Related U.S. Application Data
(60) Provisional application No. 62/088,040, filed on Dec. 5, 2014.

(51) Int. Cl. B64B 1/40; B64B 1/62

(52) U.S. Cl. CPC B64B 1/40; B64B 1/62

(57) ABSTRACT

A balloon having a descent decelerator includes an atmospheric balloon and a descent decelerator coupled with the atmospheric balloon. The descent decelerator includes a canopy spread along the upper portion of the atmospheric balloon. The canopy coupled to the atmospheric balloon with a plurality of canopy tethers at a canopy perimeter of the canopy and at a balloon perimeter of the balloon body. In a deflation configuration the canopy fills as the balloon descends and the canopy tethers suspend the atmospheric balloon from the canopy.

### CLAIM OF PRIORITY

This patent application claims the benefit of priority to U.S. Provisional Application No. 62/088,040, filed Dec. 5, 2014, which is hereby incorporated by reference herein in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever. The following notice applies to the software and data as described below and in the drawings that form a part of this document: Copyright Raven Industries, Inc.; Sioux Falls, S. Dak. All Rights Reserved.

### TECHNICAL FIELD

This document pertains generally, but not by way of limitation, to inflatable airborne structures.

### BACKGROUND

Atmospheric balloons (e.g., weather balloons, observation balloons, telecommunication balloons or the like) lift payloads to varying altitudes including, but not limited to, 60,000 feet or more above sea level. Atmospheric balloons have varying operational lifetimes that end with the atmospheric balloon returning to ground. In at least some circumstances control of when an atmospheric balloon deflates and returns to ground is achieved with a deflation mechanism that initiates deflation of the atmospheric balloon. Optionally, a system is included with the atmospheric balloon to slow the descent of the balloon and accordingly minimize damage to the balloon payload, people and property (e.g., buildings, personal property or the like).

One example of a system to slow the descent of a balloon includes an assembly coupled with the atmospheric balloon having a parachute and a drogue chute or other deployment mechanism. The drogue chute and parachute are stored within a housing and when slowing of the descent of the atmospheric balloon is desired the drogue chute is deployed (e.g., with a squib charge, actuator or the like). The deployed drogue chute fills and transmits drag to the parachute that is subsequently pulled and deployed from the housing. The parachute then relies on the descent of the atmospheric balloon relative to the atmosphere to fill the parachute and accordingly slow the balloon.

### OVERVIEW

The present inventors have recognized, among other things, that a problem to be solved can include minimizing the complexity of systems configured to slow the descent of atmospheric balloons. Systems, such as parachute systems deployed through the operation of a drogue chute require complex storage assemblies that sequentially deploy the drogue chute prior to the parachute. Additionally, a deployment mechanism, such as a squib charge, motorized actuator or the like is used to deploy the drogue chute. Deployment mechanisms add another layer of complexity to the systems.

In an example, the present subject matter can provide a solution to this problem, such as by a passively operated descent decelerator coupled with the atmospheric balloon. The descent decelerator includes a canopy spread along an upper portion of the atmospheric balloon (e.g., over at least a portion of an upper portion of the balloon) and coupled with a balloon perimeter of the balloon with a plurality of canopy tethers. The canopy tethers are spaced around the balloon perimeter (and the canopy perimeter) to centrally position the canopy relative to the atmospheric balloon. During deflation of the atmospheric balloon (e.g., opening of a remote triggered deflation port) the balloon descends and the canopy is passively filled by atmosphere. The canopy is already spread over the upper portion of the balloon and thereby readily fills even in thinner atmosphere (e.g., altitudes of 60,000 feet or more). The passive filling of the spread canopy ensures complex deployment systems (drogue chutes, squib charges, storage housings and the like) are accordingly absent from the descent decelerator described herein. As further discussed herein, the deflating atmospheric balloon is also centrally positioned according to the spacing of the canopy tethers around the balloon perimeter and the canopy perimeter. Accordingly, with deflation of the atmospheric balloon the weight of the balloon pulls the balloon body inwardly relative to the canopy and facilitates filling of the canopy previously spread over the balloon even within a thin atmosphere that would otherwise prove difficult for filling a collapsed parachute.

The present inventors have further recognized, among other things, that another problem to be solved can include decreasing the failure of decelerator deployment and enhancing the evacuation of lift gases from a deflating atmospheric balloon. Failure of a chute based system fails to slow the fall of an atmospheric balloon, and in some examples may cause damage to people, property or the payload of the balloon. Additionally, an atmospheric balloon with a blocked deflation port, for instance caused by settling of balloon material over the port during deflation, may descend unpredictably. In another example, a partially deflated balloon (e.g., with a blocked deflation portion) may interfere with the proper deployment of a parachute. For instance, if lift gases cannot properly exit the balloon sufficient descent speed may not be achieved to fill a drogue chute or generate sufficient drag in the drogue chute to deploy the parachute.

In another example, the present subject matter can provide a solution to this problem, such as by coupling a canopy of a descent decelerator with an atmospheric balloon at the perimeter of the atmospheric balloon with canopy tethers. The spaced configuration of the canopy tethers facilitates the inward contraction of the deflating atmospheric balloon. The inward contraction of the balloon facilitates the delivery of atmosphere to the spread canopy and accordingly fills the canopy even in conditions of a thin atmosphere. In another example, the canopy tethers are provided in a staggered configuration around the balloon perimeter. The filling canopy expands a portion of the balloon outward relative to the contracting portion of the balloon (e.g., between the tethers) that is contracted inward according to the weight of the atmospheric balloon optionally including the payload. The deflating balloon accordingly assumes a petaled configuration with the balloon folding according to the staggered canopy tethers and the weight of the balloon. The petalled configuration provides corrugations or filling channels that promote the passage of atmosphere through the filling channels and into the canopy. The canopy thereby consistently and reliably fills with deflation of the atmospheric balloon.

Further, a deflation port of the atmospheric balloon (e.g., at an apex fitting of the balloon) is optionally suspended with one or more apex suspension lines from the canopy. As the atmospheric balloon deflates through the deflation port the port is suspended from the canopy at an elevated position relative to the sagging remainder of the balloon by the one or more apex suspension lines. Lift gases readily move to the uppermost portion of the deflating balloon and are reliably directed through the deflation port suspended at the elevated position. Accordingly, lift gases reliably evacuate from the atmospheric balloon and minimize the likelihood of a partially filled balloon interfering with operation of the descent decelerator (e.g., the canopy).

This overview is intended to provide an overview of subject matter of the present patent application. It is not intended to provide an exclusive or exhaustive explanation of the invention. The detailed description is included to provide further information about the present patent application.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 provides a schematic view of a balloon assembly including a descent decelerator according to at least one example of the present description.

FIG. 2 provides a detailed perspective view of a balloon construction including a descent decelerator according to at least one example of the present description.

FIG. 3 provides a side view of a balloon construction in a deflated state with a deployed descent decelerator according to at least one example of the present description.

FIG. 4A provides a detailed side view of a balloon construction including a descent decelerator, in a deflated state, according to at least one example of the present description.

FIG. 4B provides a detailed perspective view of a balloon construction including a descent decelerator, in a deflated state, according to at least one example of the present description.

FIG. 5 provides a side view of a balloon construction including a descent decelerator, in a deflated state, according to at least another example of the present description.

FIG. 6A provides a detailed side view of a balloon construction including a descent decelerator, in a deflated state, according to at least another example of the present description.

FIG. 6B provides a close-up perspective view of a balloon construction including a descent decelerator, in a deflated state, according to at least one example of the present description.

FIG. 7 provides a block diagram of one example of a method for decelerating a descending balloon according to the present description.

### DETAILED DESCRIPTION

This subject matter is designed to safely descend a zero pressure or super pressure balloon, also known as atmospheric balloons, (with or without a payload attached) to the ground or ocean. Unlike other balloon parachute systems a descent decelerator canopy is coupled with the upper portion of a balloon. As the lift gas is evacuated and the balloon (with or without the payload) starts to descend the gas bubble within the balloon body reduces in size and the integrated canopy passively inflates (fills) and stabilizes the descent. The filled canopy maintains the apex of the balloon upright so that lift gas continues to evacuate during descent (e.g., through a deflation port centrally suspended above the remainder of the balloon).

This design saves weight and eliminates complicated payload release, or parachute deployment mechanisms and hardware (e.g., storage housings, squibs, drogue chutes or the like). The canopy is coupled with the balloon through canopy tethers including, but not limited to, lines, cords, cables, ribbons or tapes of various materials sewn or sealed onto one or more of the canopy apex or perimeter and the balloon perimeter, or a skirt coupled with the balloon and canopy perimeters. The canopy tethers optionally attach to one or more balloon load members extending between the apexes of a balloon (e.g., tendons including, but not limited to, cords, cables, ribbons, tapes or the like) or apex fitting if one is present. The canopy tethers, in another example, are coupled with load members installed on the balloon that are optionally designated for use with the canopy. Stated another way, the load members can be provided as a coupling feature specifically (e.g., entirely or primarily) for the canopy tethers where the balloon is without dedicated load members extending from the balloon apex fitting to a bottom fitting. Materials used for construction of the canopy include, but are not limited to, fabrics, cordage, tapes, various films, or hybrids of two or more of these materials. One example of such a material includes a nylon fabric, such as military grade nylon fabric PIA-C-7020 (100-120 CFM). Optionally, the materials are opaque, transparent or an intermediate therebetween to ensure solar exposure or insulation of the balloon from solar exposure as desired.

The descent decelerator includes at least two configurations. A first configuration includes the apex of the canopy (or an inner portion of the canopy nearer to the apex than the canopy perimeter) attached to the upper portion of the balloon, such as the balloon apex. Attaching the canopy to the upper portion of the balloon generates higher drag for the same size canopy as the canopy is retained in a flatter configuration with a larger effective radius (e.g., presents an expanded profile relative to the direction of descent). Further, the canopy lifts the upper portion of the balloon (with a deflation port) relative to the remainder of the balloon to facilitate continued lift gas extraction.

The second configuration includes the balloon upper portion, such as an apex, detached from the canopy, and the canopy is allowed to lift completely up in a curved (e.g., more parabolic) shape relative to the first configuration during filing. The curved shape facilitates reliable filling and maintenance of filling during descent. In another example, the attachment mechanism between the balloon upper portion (e.g, an apex fitting) and the canopy is lengthened or shortened in the form of apex suspension lines to tune the placement of the upper portion of the balloon during descent for lift gas evacuation while at the same time controlling the shape of the filled canopy between flat and curved shapes for drag and reliable filling, respectively.

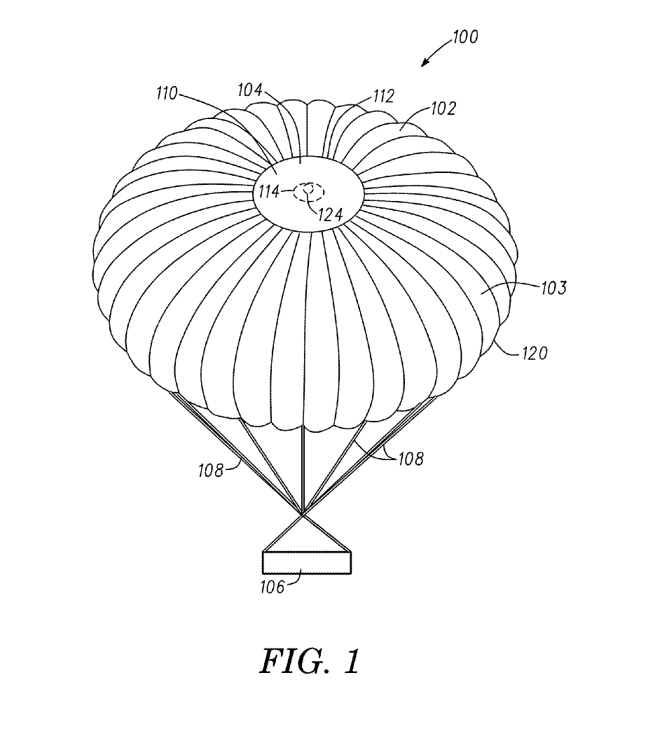

FIG. 1 provides a schematic view of a balloon construction 100 including a descent decelerator 104 according to the present description. In an example, the balloon construction 100 includes an atmospheric balloon 102 having a balloon body 103. The balloon body 103 includes one or more of the membrane of the atmospheric balloon 102, tendons 108, fittings or the like. The descent decelerator 104 is coupled with the atmospheric balloon 102. The descent decelerator includes, in an example, a canopy 110, as further described herein.

The balloon assembly optionally further includes a payload 106 that is suspended from atmospheric balloon 102 by tendons 108. In an example, when the atmospheric balloon 102 is in an inflated configuration (as provided in FIG. 1), the canopy 110 is spread along the upper portion 112 of the atmospheric balloon 102 and accordingly stored thereon. Optionally, the canopy 110 includes a material at least partially translucent to sunlight, and with the atmospheric balloon 102 in the inflated configuration sunlight passes through the canopy spread along the upper portion 112 of the atmospheric balloon 102, for instance to warm the balloon.

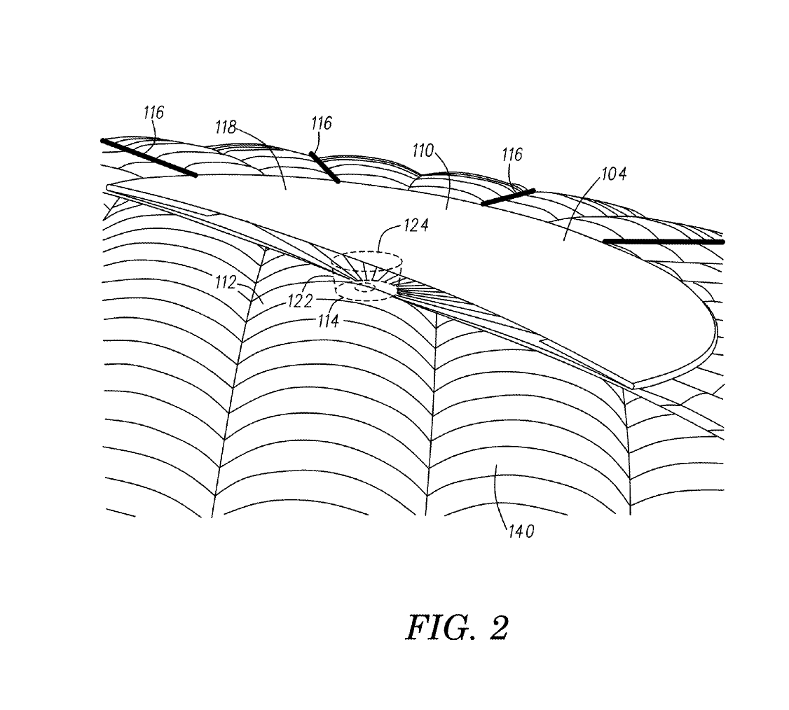

FIG. 2 provides a detailed sectional view of the upper portion of the balloon assembly 100 and specifically, the upper portion 112 of the balloon body. In at least one example, atmospheric balloon 102 includes an apex fitting 114 that is coupled with an upper portion 112 of balloon body 103. As further illustrated, the descent decelerator 104 includes a plurality of canopy tethers 116 (illustrated in bold for clarity) that are coupled to the canopy 110. In an example, each of the canopy tethers 116 is coupled at a canopy perimeter 118 of the canopy 110 and at a balloon perimeter 120 of the balloon body 103 (see FIG. 1) spaced from the balloon apex including the optional apex fitting 114. The construction 100 optionally further includes at least one apex suspension line 122 that couples the apex fitting 114 to a canopy inner portion. The bottom portion of the sectional view of FIG. 2 further illustrates the interior of the atmospheric balloon 102.

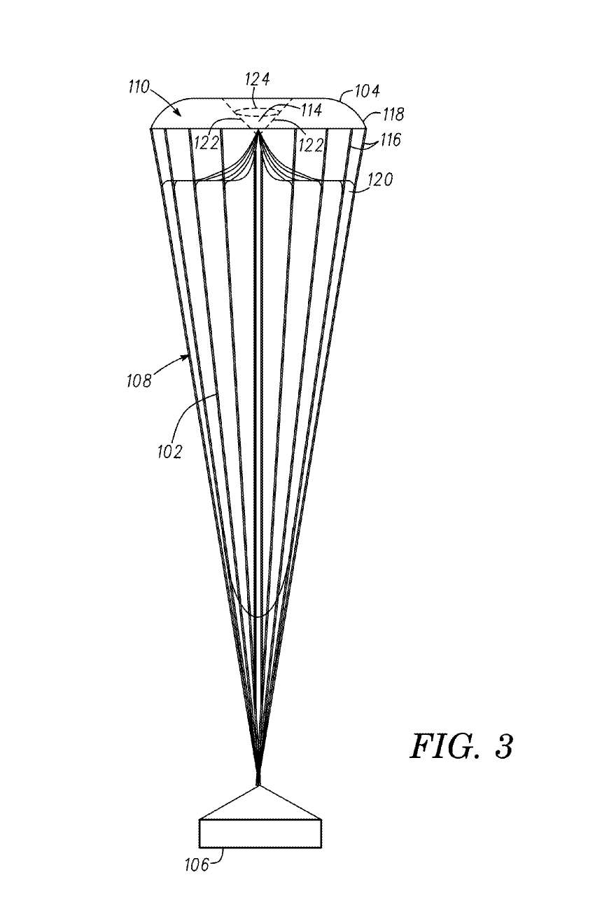

FIG. 3 provides a side view of the balloon assembly 100 in a partially deflated configuration. The figure illustrates the assembly 100 when the atmospheric balloon 102 is in the deflated configuration and the canopy 110 is in a “filled” configuration. In one example, when the atmospheric balloon 102 is partially or fully deflated, the plurality of canopy tethers 116 coupled with the balloon perimeter 120 suspend the atmospheric balloon 102 below the canopy 110. As shown, in an example the atmospheric balloon 102 is centrally suspended beneath the canopy 110. The tethers 116 form a cage-like formation around the atmospheric balloon 102. Tension on the tethers 116 generated by the weight of the balloon 102 and the payload 106 and countered by drag on the canopy 110 minimizes (e.g., eliminates or reduces) whipping of the high altitude balloon 102 in crosswinds. Further the tethers 116 constrict the balloon 102 relative to the canopy 110 increasing the likelihood of successful filling of the canopy 110 with rising air flow (e.g., descent of the balloon 102). Additionally, the at least one apex suspension line 122 suspends the apex suspension line 114 near an uppermost portion of the atmospheric balloon 102.

As further illustrated in FIGS. 1-3, the canopy 110, in one example, includes a canopy vent orifice 124 (e.g., including a ring fitting or the like in the canopy). The canopy vent orifice 124 allows for the evacuation of lift gas from the atmospheric balloon 102 (e.g., from a deflation port in the apex fitting 114) through the canopy 110. Optionally, the apex fitting 114 of the atmospheric balloon 102 includes a remotely operated deflation port. The deflation port (as part of the apex fitting 114 or a separate component) is suspended near the uppermost portion of the high altitude balloon 102 in the deflation configuration (see, e.g., FIG. 3) by one or more apex suspension lines 122, for instance from the canopy vent orifice 124.

Referring again to FIGS. 2 and 3, in at least some examples the apex suspension line 122 includes a plurality of apex suspension lines. Optionally, the apex line (or lines 122) suspend the apex fitting 114 at or below a canopy edge 118 of the canopy 110 in the deflation configuration of the atmospheric balloon 102 to facilitate the escape of lift gases from the canopy. Additionally or alternatively, the apex suspension line or lines 122 suspend the apex fitting 114 above the balloon perimeter couplings (discussed below) in the deflation configuration of the atmospheric balloon. In one example, the suspension lines 122 are coupled around the canopy vent orifice 124 and extend to the apex fitting 114. The apex suspension line (or lines) 122 anchor the inner portion of the canopy 110 relative to the atmospheric balloon 102. By shortening or lengthening the apex suspension line (or lines) 122, the initial filling of the canopy 110 is altered—i.e., short suspension lines will constrain vertical filling of the canopy 110 while promoting radial filling and spreading of the canopy, while longer suspensions lines will facilitate increased vertical filling of the canopy 110.

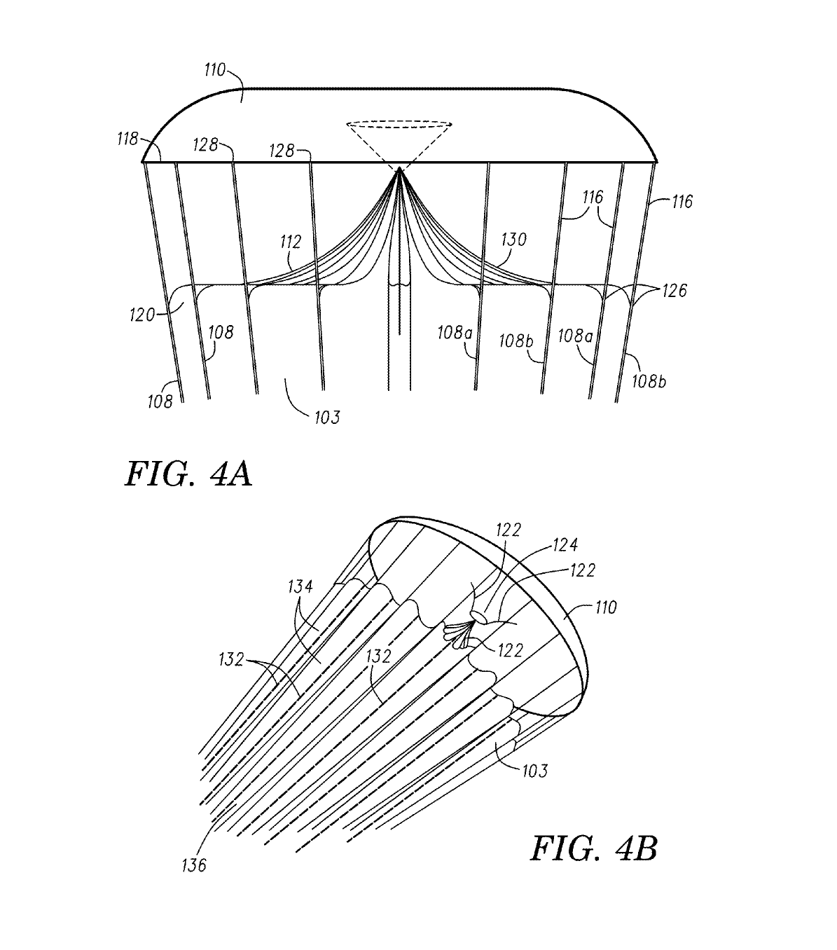

The balloon assembly 100 in deflated state (as provided in FIG. 3) is further understood by a detailed view of the assembly as provided in FIGS. 4A and 4B. FIG. 4A further illustrates that in an example, the plurality of canopy tethers 116 are coupled with the balloon perimeter 120 at balloon couplings 126 spaced around the balloon perimeter 120. Additionally the plurality of canopy tethers 116 are, in an example, coupled with the canopy perimeter 118 at canopy perimeter couplings 128 spaced around the canopy perimeter 118. As illustrated in FIGS. 3 and 4A, the canopy 110 is spread along the upper portion 112 of the atmospheric balloon 102 according to the spacing of the balloon perimeter couplings 126 and canopy perimeter couplings 128.

FIG. 4A further illustrates balloon tendons 108 that provide support to the material of the atmospheric balloon while inflated, constrain inflation to a lobed pumpkin shape, and that are optionally used to assist with securing the payload 103 illustrated in FIGS. 1 and 3. As shown, the balloon perimeter couplings 126 are in an example provided at the tendons 108 around the balloon body 103. The balloon perimeter couplings 126, in another example, correspond in a one-to-one correlation to the tendons 108 around balloon body 103. Alternatively, in another example, the balloon tendons include first and second sets of tendons (108a and 108b) around the balloon body. The balloon perimeter couplings 126 in this example are provided at the first set of tendons 108a such that the balloon perimeter couplings 126 are staggered relative to the second set of tendons 108b. As described herein, the optional staggering of the balloon perimeter couplings facilitates the deflation of the atmospheric balloon 102 and the filling of the canopy 110.

As previously noted, the atmospheric balloon 102 includes a payload 106. In one example, payload 106 is coupled with the balloon body 103 and tendons 108. In the deflation configuration (such as the configuration shown in FIG. 3) the tendons 108 (coupled with the canopy tethers 116) suspend the payload 106 beneath the canopy 110.

FIG. 4B illustrates a perspective view of the assembly 100 shown in FIG. 4A. FIG. 4B illustrates a first balloon portion 132 of the balloon body 103 (e.g., balloon membrane) that is contracted inwardly according to the weight of the atmospheric balloon 102 and optionally the payload 106. Further, the balloon assembly 100 includes a second balloon portion 134 of the balloon body 103 coupled with the canopy tethers 116 that expands outward relative to the first balloon portion 132 according to filling of the canopy 110. The alternating first and second balloon portions 132, 134 facilitate the generation of filling channels 136 extending along the balloon body 103 toward the canopy 110. As described herein, the filling channels provide passages along the balloon 102 that communicate with the underside of the canopy 110. Air passing through and along the filling channels 136 is received in the canopy 110 and assists with deployment of the canopy. FIG. 4B also provides a more clear view of apex suspension lines 122.

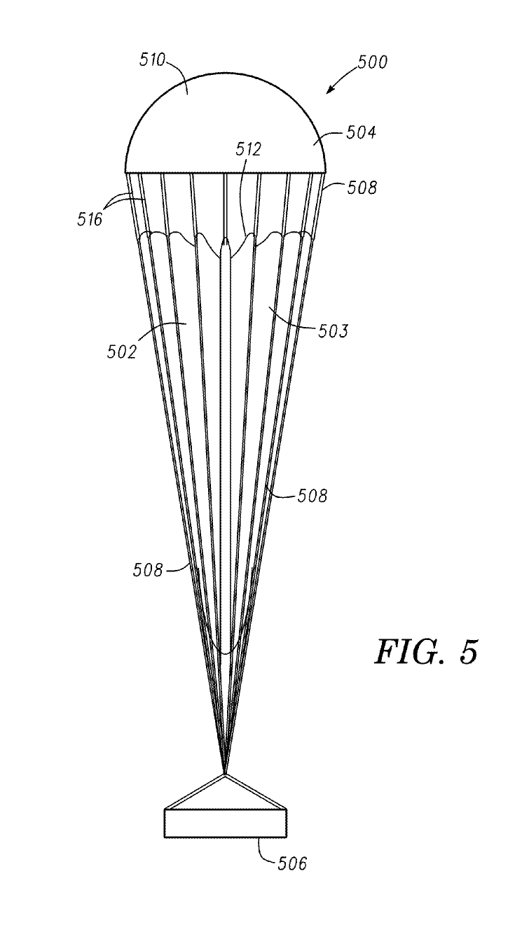

FIG. 5 provides an alternative example of a balloon assembly 500 including a descent decelerator according to the present description. The balloon assembly 500 includes a atmospheric balloon 502 (here illustrated in a partially deflated state) including a balloon body 503. In an example, the balloon assembly 500 further includes a descent decelerator 504 coupled with the atmospheric balloon 502. In an example, the descent decelerator includes a canopy 510 and a plurality of canopy tethers 516 that couple the canopy 510 with the atmospheric balloon 502. Similar in at least some regards to the assembly 100 illustrated and described in FIGS. 1-4, in the present assembly 500 the atmospheric balloon 502 transitions between an inflated configuration (see, e.g. FIG. 1) and a deflated configuration (shown in FIG. 5). In the inflated configuration, the canopy 510 is spread along an upper portion 512 of the atmospheric balloon 502 (similar to upper portion 112 of atmospheric balloon 102 of FIG. 1). In the assembly 500 the canopy 510 opens into a relatively curved shape (e.g., parabolic) compared to the assembly 100. This is due in part to longer suspension lines 122 (see FIG. 3, 4A or 4B), or alternatively, no suspension lines.

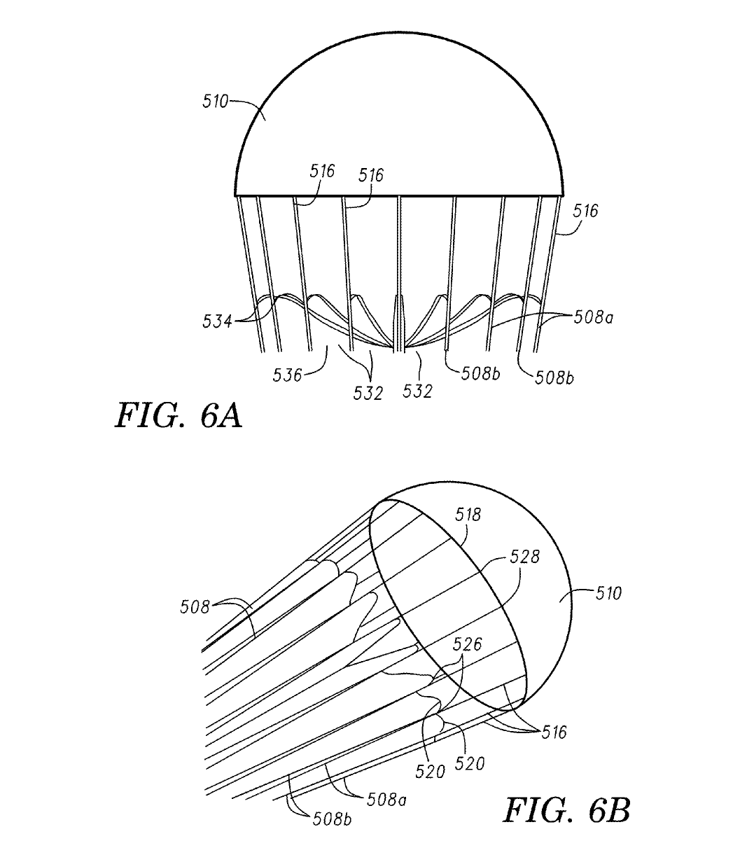

FIG. 6A offers a close-up view of the canopy 510 and upper portion 512 of atmospheric balloon 502. As further illustrated, in the deflation configuration a first balloon portion 532 of the balloon body 503 is contracted inward according to the weight of the atmospheric balloon 502 (and optionally the weight of the payload 506). The assembly 500 further includes a second balloon portion 534 of the balloon body 503 coupled with the canopy tethers 516. The second balloon portion 534 is expanded outward relative to the first balloon portion 532 according to filling of the canopy 510 (e.g., drag). In one example a plurality of filling channels 536 are provided along the atmospheric balloon 502 and extend toward the canopy 510. The plurality of filling channels 536 are formed, at least in part, according to the respective contracted first portions 532 and expanded second balloon portions 534 in combination with the canopy tethers 516 suspending the atmospheric balloon 502 from the canopy 510.

FIG. 6B provides a detailed perspective view of the balloon assembly 500. In at least one example the canopy tethers 516 include balloon perimeter couplings 526 that couple the canopy tethers 516 to a balloon perimeter 520. The assembly 500, in an example, further includes canopy perimeter couplings 528 that couple the canopy tethers 516 to a canopy perimeter 518. The balloon perimeter couplings 526 are spaced around the balloon perimeter 520 and the canopy perimeter couplings 528 are spaced around the canopy perimeter 518. The plurality of canopy tethers 516 are, in the present example, thereby spaced around the canopy perimeter 518 and the balloon perimeter 520 according to the spacing of the balloon perimeter couplings 526 and the canopy perimeter couplings 528. Stated another way, the couplings 526, 528 are distributed around the balloon 502 and the canopy 510 to centrally (e.g., including near centrally) location the balloon 502 relative to the canopy 510 and to ensure positioning of the canopy 510 above the balloon 502.

In at least one example, each of the balloon perimeter couplings 526 of the respective canopy tethers 516 are coupled with respective tendons 508 of the atmospheric balloon 502. Optionally, the tendons 508 may include a first set of tendons 508a and a second set of tendons 508b. As shown in FIG. 6B, the first set of tendons 508a are interposed with at least some tendons of the second set of tendons 508b. As shown in both FIGS. 6A and 6B, the plurality of filling channels 536 are spaced around the balloon perimeter 520 according to spacing of the plurality of canopy tethers 516 (and the respective couplings 526, 528) around the balloon perimeter 520 around the canopy perimeter 518, respectively.

Returning to FIG. 5, in an example, atmospheric balloon 502 includes a payload 506 that is coupled beneath the balloon body with the respective tendons 508. In the deflated configuration the canopy tethers 516 and the respective tendons 508 coupled with the canopy tethers 516 suspend the payload 506 from the canopy 510. Further, in the deflation configuration the plurality of canopy tethers 516 coupled around the canopy perimeter 518 and balloon perimeter 520 centrally suspend the atmospheric balloon 502 below the canopy 510. The canopy 510 is centrally suspended above the atmospheric balloon 502 by the plurality of canopy tethers 516. In one example, as illustrated in FIGS. 5-7, the canopy 510 is spread along the upper portion 512 of the atmospheric balloon 502 according to spacing of the plurality of canopy tethers 528 around a canopy perimeter 518 and balloon perimeter 520.

Like the assembly 100 in FIG. 1, assembly 500 also optionally includes an apex fitting coupled with the upper portion 512 of atmospheric balloon 502 and surrounded by the plurality of canopy tethers 516. In the deflation configuration the apex fitting is positioned within the balloon perimeter 520. The apex fitting can include at least one apex suspension line (e.g. line or lines 122) that couple the apex fitting (e.g. 114) to a canopy inner portion. The apex suspension line suspends the apex fitting near an uppermost portion of the atmospheric balloon in the deflation configuration. Additionally, in an example, the apex fitting includes a deflation port, and the at least one apex suspension line suspends the deflation port near the uppermost portion of the atmospheric balloon in the deflation configuration. These elements are also further described herein and shown in FIGS. 1-4.

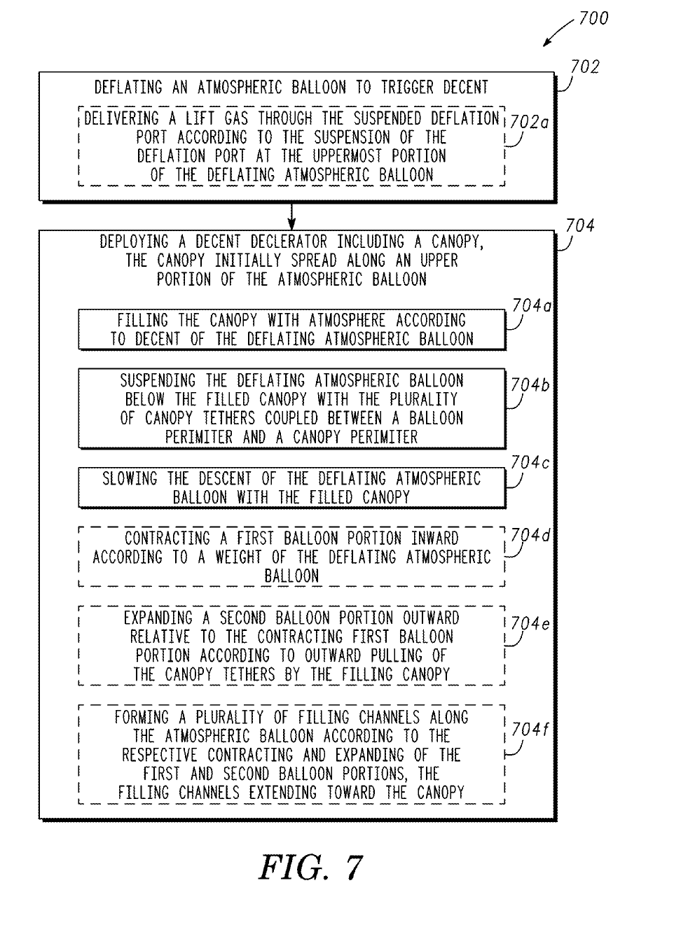

In another example, the present description relates to a method for decelerating a descending balloon. A block diagram of such a method 700 is provided in FIG. 7. The method 700 includes deflating an atmospheric balloon to trigger descent 702, and deploying a descent decelerator including a canopy 704, where the canopy is initially spread along an upper portion of the atmospheric balloon. Deploying a descent decelerator including a canopy (704) can further include a number of actions. For example, the deployment 704 further includes filling the canopy with atmosphere according to descent of the deflating atmospheric balloon 704b. In an additional example, the deployment 704 also includes suspending the deflating atmospheric balloon below the filled canopy with the plurality of canopy tethers coupled between a balloon perimeter of the atmospheric balloon and a canopy perimeter of the canopy 704b. Further, the deployment 704 includes slowing the descent of the deflating atmospheric balloon with the filled canopy 704c. Deflating the atmospheric balloon to trigger descent optionally includes delivering a lift gas through the suspended deflation port according to the suspension of the deflation port at the uppermost portion of the deflating atmospheric balloon 702a.

In some examples, deployment 704 includes further actions. An example of actions include contracting a first balloon portion inward according to a weight of the deflating atmospheric balloon 705c. Additionally, deployment may include expanding a second balloon portion outward relative to the contracting first balloon portion according to outward pulling of the canopy tethers by the filling canopy 705d. Further exemplary deployment includes forming a plurality of filling channels along the atmospheric balloon according to the respective contracting and expanding of the first and second balloon portions, the filling channels extending toward the canopy 705e, and filling the canopy includes delivering atmosphere through the filling channels to the canopy according to descent of the deflating atmospheric balloon 705f.

In at least one example, the deflation port of the atmospheric balloon is coupled with the canopy, and method 700 further includes suspending the deflation port at an uppermost portion of the deflating atmospheric balloon according to deployment of the canopy. As noted above in the earlier figures, in some examples, the deflation port includes an apex fitting coupled with the upper portion of the atmospheric balloon and at least one apex suspension line couples the apex fitting with the canopy. In such an example, the method may include suspending the deflation port includes suspending the apex fitting with the at least one apex suspension line. In an example where the central portion of the canopy is coupled with the atmospheric balloon, filling the canopy includes constraining vertical filling of the canopy according to the coupling of the central portion of the canopy with the atmospheric balloon, and expanding the radius of the canopy from the central portion according to constraint of vertical filling.

Where the atmospheric balloon (e.g. 102 or 502) includes a payload (e.g. 106 or 506) below the balloon body with tendons (e.g. 108 or 508) suspended around the balloon body and a plurality of canopy tethers (e.g. 116 or 516) coupled with the tendons, the deployment, in an example, further includes suspending the deflating atmospheric balloon below the filled canopy includes the plurality of canopy tethers coupled with the tendons suspending the payload from the filled canopy. Additionally, or alternatively, suspending the deflating atmospheric balloon below the filled canopy with the plurality of canopy tethers (704b) includes forming a tether cage with the canopy tethers surrounding the balloon body, the canopy tethers tensioned between the payload and the canopy, and stowing the balloon body within the tether cage.

In one example, method 700 additionally includes venting atmosphere from the filled canopy, venting minimizing shock between the canopy and the atmospheric balloon during deploying of the descent decelerator. Where the canopy of the assembly includes a material that is at least partially translucent to sunlight, the method 700, in one example, also includes passing sunlight through the canopy spread along the upper portion of the atmospheric balloon while the atmospheric balloon is in an inflated configuration.

### VARIOUS NOTES & EXAMPLES

Example 1 can include subject matter, such as can include a balloon including a descent decelerator comprising: an atmospheric balloon, the atmospheric balloon includes a balloon body and an apex fitting coupled with an upper portion of the balloon body; a descent decelerator coupled with the atmospheric balloon, the descent decelerator includes: a canopy spread along the upper portion of the atmospheric balloon in an inflated configuration of the atmospheric balloon, a plurality of canopy tethers coupling the canopy with the atmospheric balloon, each of the canopy tethers is coupled at a canopy perimeter of the canopy and at a balloon perimeter of the balloon body spaced from the apex fitting, and at least one apex suspension line coupling the apex fitting to a canopy inner portion; and in a deflation configuration of the atmospheric balloon the plurality of canopy tethers coupled with balloon perimeter suspend the atmospheric balloon below the canopy, and the at least one apex suspension line suspends the apex fitting near an uppermost portion of the atmospheric balloon.

Example 2 can include, or can optionally be combined with the subject matter of Example 1, to optionally include wherein the apex fitting includes a deflation port, and the deflation port is suspended near the uppermost portion of the atmospheric balloon in the deflation configuration by the apex suspension line.

Example 3 can include, or can optionally be combined with the subject matter of one or any combination of Examples 1 or 2 to optionally include wherein the plurality of canopy tethers are coupled with the balloon perimeter at balloon perimeter couplings spaced around the balloon perimeter, and the plurality of canopy tethers are coupled with the canopy perimeter at canopy perimeter couplings spaced around the canopy perimeter.

Example 4 can include, or can optionally be combined with the subject matter of one or any combination of Examples 1-3 to optionally include wherein the canopy is spread along the upper portion of the atmospheric balloon according to the spacing of the balloon perimeter couplings and the canopy perimeter couplings.

Example 5 can include, or can optionally be combined with the subject matter of one or any combination of Examples 1-4 to optionally include wherein the balloon perimeter couplings are provided at tendons around the balloon body.

Example 6 can include, or can optionally be combined with the subject matter of Examples 1-5 to optionally include wherein the tendons include first and second sets of tendons positioned around the balloon body, and the balloon perimeter couplings are provided at the first set of tendons staggered relative to the second set of tendons.

Example 7 can include, or can optionally be combined with the subject matter of Examples 1-6 to optionally include wherein the atmospheric balloon includes a payload coupled with the balloon body and the tendons, and in the deflation configuration the canopy tethers coupled with the tendons suspend the payload beneath the canopy.

Example 8 can include, or can optionally be combined with the subject matter of Examples 1-7 to optionally include wherein the canopy includes: a canopy vent orifice at the canopy inner portion, and the at least one apex suspension line includes a plurality of apex suspension lines coupled around the canopy vent orifice and extending to the apex fitting.

Example 9 can include, or can optionally be combined with the subject matter of Examples 1-8 to optionally include wherein the plurality of canopy tethers are coupled with the balloon perimeter at balloon perimeter couplings spaced around the balloon perimeter, and the at least one apex suspension line suspends the apex fitting above the balloon perimeter couplings in the deflation configuration of the atmospheric balloon.

Example 10 can include, or can optionally be combined with the subject matter of Examples 1-9 to optionally include wherein the at least one apex suspension line suspends the apex fitting at or below a canopy edge of the canopy in the deflation configuration of the atmospheric balloon.

Example 11 can include, or can optionally be combined with the subject matter of Examples 1-10 to optionally include wherein in the deflation configuration the atmospheric balloon includes: a first balloon portion of the balloon body contracted inward according to the weight of the atmospheric balloon, a second balloon portion of the balloon body coupled with the canopy tethers expanded outward relative to the first balloon portion according to filling of the canopy, and a plurality of filling channels extending along the balloon body toward the canopy according to the respective contracted and expanded first and second balloon portions.

Example 12 can include, or can optionally be combined with the subject matter of Examples 1-11 to optionally include wherein the canopy includes a material at least partially translucent to sunlight, and in the inflated configuration sunlight passes through the canopy spread along the upper portion of the atmospheric balloon.

Example 13 can include, or can optionally be combined with the subject matter of Examples 1-12 to optionally include a balloon including a descent decelerator comprising: an atmospheric balloon including a balloon body; a descent decelerator coupled with the atmospheric balloon, the descent decelerator includes a canopy and a plurality of canopy tethers coupling the canopy with the atmospheric balloon; and wherein the atmospheric balloon transitions between an inflated configuration and a deflation configuration: in the inflated configuration the canopy is spread along an upper portion of the atmospheric balloon, and in the deflation configuration a first balloon portion of the balloon body is contracted inward according to the weight of the atmospheric balloon, a second balloon portion of the balloon body coupled with the canopy tethers is expanded outward relative to the first balloon portion according to filling of the canopy, a plurality of filling channels extend along the atmospheric balloon toward the canopy according to the respective contracted and expanded first and second balloon portions, and the canopy tethers suspend the atmospheric balloon from the canopy.

Example 14 can include, or can optionally be combined with the subject matter of Examples 1-13 to optionally include wherein each of the canopy tethers of the plurality of canopy tethers include a balloon perimeter coupling that couples the canopy tether to a balloon perimeter and a canopy perimeter coupling that couples the canopy tether to a canopy perimeter, the balloon perimeter couplings are spaced around the balloon perimeter, and the canopy perimeter couplings are spaced around the canopy perimeter, and the plurality of canopy tethers are spaced around the canopy perimeter and the balloon perimeter according to the spacing of the balloon perimeter couplings and the canopy perimeter couplings.

Example 15 can include, or can optionally be combined with the subject matter of Examples 1-14 to optionally include wherein each of the balloon perimeter couplings of the plurality of canopy tethers are coupled with respective tendons of the atmospheric balloon.

Example 16 can include, or can optionally be combined with the subject matter of Examples 1-15 to optionally include wherein the respective tendons include a first set of tendons, and at least some of the tendons of the first set of tendons are interposed with at least some tendons of a second set of tendons.

Example 17 can include, or can optionally be combined with the subject matter of Examples 1-16 to optionally include wherein the atmospheric balloon includes a payload coupled beneath the balloon body with the respective tendons, and in the deflated configuration the canopy tethers and the respective tendons coupled with the canopy tethers suspend the payload from the canopy.

Example 18 can include, or can optionally be combined with the subject matter of Examples 1-17 to optionally include wherein the canopy is spread along the upper portion of the atmospheric balloon according to spacing of the plurality of canopy tethers around a canopy perimeter and a balloon perimeter.

Example 19 can include, or can optionally be combined with the subject matter of Examples 1-18 to optionally include wherein the plurality of filling channels are spaced around a balloon perimeter according to spacing of the plurality of canopy tethers around the balloon perimeter.

Example 20 can include, or can optionally be combined with the subject matter of Examples 1-19 to optionally include wherein in the deflation configuration the plurality of canopy tethers coupled around a canopy perimeter and a balloon perimeter centrally suspend the atmospheric balloon below the canopy.

Example 21 can include, or can optionally be combined with the subject matter of Examples 1-20 to optionally include wherein the canopy is centrally suspended above the atmospheric balloon by the plurality of canopy tethers coupled around a balloon perimeter and a canopy perimeter.

Example 22 can include, or can optionally be combined with the subject matter of Examples 1-21 to optionally include an apex fitting coupled with the upper portion of atmospheric balloon and surrounded by the plurality of canopy tethers, and in the deflation configuration the apex fitting is positioned within the balloon perimeter.

Example 23 can include, or can optionally be combined with the subject matter of Examples 1-22 to optionally include wherein the descent decelerator includes at least one apex suspension line coupling the apex fitting to a canopy inner portion, the apex suspension line suspends the apex fitting near an uppermost portion of the atmospheric balloon in the deflation configuration.

Example 24 can include, or can optionally be combined with the subject matter of Examples 1-23 to optionally include wherein the apex fitting includes a deflation port, and the at least one apex suspension line suspends the deflation port near the uppermost portion of the atmospheric balloon in the deflation configuration.

Example 25 can include, or can optionally be combined with the subject matter of Examples 1-24 to optionally include a method for decelerating a descending balloon comprising: deflating an atmospheric balloon to trigger descent; deploying a descent decelerator including a canopy, the canopy is initially spread along an upper portion of the atmospheric balloon, deploying including: filling the canopy with atmosphere according to descent of the deflating atmospheric balloon, and suspending the deflating atmospheric balloon below the filled canopy with the plurality of canopy tethers coupled between a balloon perimeter of the atmospheric balloon and a canopy perimeter of the canopy; and slowing the descent of the deflating atmospheric balloon with the filled canopy.

Example 26 can include, or can optionally be combined with the subject matter of Examples 1-25 to optionally include wherein deploying the descent decelerator includes: contracting a first balloon portion inward according to a weight of the deflating atmospheric balloon, expanding a second balloon portion outward relative to the contracting first balloon portion according to outward pulling of the canopy tethers by the filling canopy, forming a plurality of filling channels along the atmospheric balloon according to the respective contracting and expanding of the first and second balloon portions, the filling channels extending toward the canopy, and filling the canopy includes delivering atmosphere through the filling channels to the canopy according to descent of the deflating atmospheric balloon.

Example 27 can include, or can optionally be combined with the subject matter of Examples 1-26 to optionally include wherein a deflation port of the atmospheric balloon is coupled with the canopy, and comprising suspending the deflation port at an uppermost portion of the deflating atmospheric balloon according to deployment of the canopy.

Example 28 can include, or can optionally be combined with the subject matter of Examples 1-27 to optionally include wherein deflating the atmospheric balloon includes delivering a lift gas through the suspended deflation port according to the suspension of the deflation port at the uppermost portion of the deflating atmospheric balloon.

Example 29 can include, or can optionally be combined with the subject matter of Examples 1-28 to optionally include wherein the deflation port is included with an apex fitting coupled with the upper portion of the atmospheric balloon and at least one apex suspension line couples the apex fitting with the canopy, and suspending the deflation port includes suspending the apex fitting with the at least one apex suspension line.

Example 30 can include, or can optionally be combined with the subject matter of Examples 1-29 to optionally include wherein a central portion of the canopy is coupled with the atmospheric balloon, and filling the canopy with atmosphere includes: constraining vertical filling of the canopy according to the coupling of the central portion of the canopy with the atmospheric balloon, and expanding the radius of the canopy from the central portion according to constraint of vertical filling.

Example 31 can include, or can optionally be combined with the subject matter of Examples 1-30 to optionally include wherein the atmospheric balloon includes a payload coupled below a balloon body with tendons spaced around the balloon body, and the plurality of canopy tethers are coupled with the tendons, and suspending the deflating atmospheric balloon below the filled canopy includes the plurality of canopy tethers coupled with the tendons suspending the payload from the filled canopy.

Example 32 can include, or can optionally be combined with the subject matter of Examples 1-31 to optionally include wherein the atmospheric balloon includes a payload coupled below a balloon body, and the payload is suspended from the filled canopy with suspending of the deflating atmospheric balloon from the filled canopy, and suspending the deflating atmospheric balloon below the filled canopy with the plurality of canopy tethers includes: forming a tether cage with the canopy tethers surrounding the balloon body, the canopy tethers tensioned between the payload and the canopy, and stowing the balloon body within the tether cage.

Example 33 can include, or can optionally be combined with the subject matter of Examples 1-32 to optionally include venting atmosphere from the filled canopy, venting minimizing shock between the canopy and the atmospheric balloon during deploying of the descent decelerator.

Example 34 can include, or can optionally be combined with the subject matter of Examples 1-33 to optionally include wherein the canopy includes a material at least partially translucent to sunlight, and comprising passing sunlight through the canopy spread along the upper portion of the atmospheric balloon while the atmospheric balloon is in an inflated configuration.

Each of these non-limiting examples can stand on its own, or can be combined in any permutation or combination with any one or more of the other examples.

The above detailed description includes references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments can be used, such as by one of ordinary skill in the art upon reviewing the above description. The Abstract is provided to comply with 37 C.F.R. §1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A balloon including a descent decelerator comprising:
an atmospheric balloon, the atmospheric balloon includes a balloon body and an apex fitting coupled with an upper portion of the balloon body;
a descent decelerator coupled with the atmospheric balloon, the descent decelerator includes:
a canopy spread along the upper portion of the atmospheric balloon in an inflated configuration of the atmospheric balloon,
a plurality of canopy tethers coupling the canopy with the atmospheric balloon, each of the canopy tethers is coupled at a canopy perimeter of the canopy and at a balloon perimeter of the balloon body spaced from the apex fitting, and
at least one apex suspension line coupling the apex fitting to a canopy inner portion; and
in a deflation configuration of the atmospheric balloon the plurality of canopy tethers coupled with balloon perimeter suspend the atmospheric balloon below the canopy, and the at least one apex suspension line suspends the apex fitting near an uppermost portion of the atmospheric balloon.

2. The balloon including the descent decelerator of claim 1, wherein the apex fitting includes a deflation port, and the deflation port is suspended near the uppermost portion of the atmospheric balloon in the deflation configuration by the apex suspension line.

3. The balloon including the descent decelerator of claim 1, wherein the plurality of canopy tethers are coupled with the balloon perimeter at balloon perimeter couplings spaced around the balloon perimeter, and the plurality of canopy tethers are coupled with the canopy perimeter at canopy perimeter couplings spaced around the canopy perimeter.

4. The balloon including the descent decelerator of claim 3, wherein the canopy is spread along the upper portion of the atmospheric balloon according to the spacing of the balloon perimeter couplings and the canopy perimeter couplings.

5. The balloon including the descent decelerator of claim 1, wherein the balloon perimeter couplings are provided at tendons around the balloon body.

6. The balloon including the descent decelerator of claim 5, wherein the tendons include first and second sets of tendons positioned around the balloon body, and the balloon perimeter couplings are provided at the first set of tendons staggered relative to the second set of tendons.

7. The balloon including the descent decelerator of claim 1, wherein the atmospheric balloon includes a payload coupled with the balloon body and the tendons, and in the deflation configuration the canopy tethers coupled with the tendons suspend the payload beneath the canopy.

8. The balloon including the descent decelerator of claim 1, wherein the canopy includes:
a canopy vent orifice at the canopy inner portion, and
the at least one apex suspension line includes a plurality of apex suspension lines coupled around the canopy vent orifice and extending to the apex fitting.

9. The balloon including the descent decelerator of claim 1, wherein the plurality of canopy tethers are coupled with the balloon perimeter at balloon perimeter couplings spaced around the balloon perimeter, and
the at least one apex suspension line suspends the apex fitting above the balloon perimeter couplings in the deflation configuration of the atmospheric balloon.

10. The balloon including the descent decelerator of claim 9, wherein the at least one apex suspension line suspends the apex fitting at or below a canopy edge of the canopy in the deflation configuration of the atmospheric balloon.

11. The balloon including the descent decelerator of claim 1, wherein in the deflation configuration the atmospheric balloon includes:
a first balloon portion of the balloon body contracted inward according to the weight of the atmospheric balloon,
a second balloon portion of the balloon body coupled with the canopy tethers expanded outward relative to the first balloon portion according to filling of the canopy, and
a plurality of filling channels extending along the balloon body toward the canopy according to the respective contracted and expanded first and second balloon portions.

12. The balloon including the descent decelerator of claim 1, wherein the canopy includes a material at least partially translucent to sunlight, and in the inflated configuration sunlight passes through the canopy spread along the upper portion of the atmospheric balloon.

13. A balloon including a descent decelerator comprising:
an atmospheric balloon including a balloon body;
a descent decelerator coupled with the atmospheric balloon, the descent decelerator includes a canopy and a plurality of canopy tethers coupling the canopy with the atmospheric balloon; and
wherein the atmospheric balloon transitions between an inflated configuration and a deflation configuration:
in the inflated configuration the canopy is spread along an upper portion of the atmospheric balloon, and
in the deflation configuration a first balloon portion of the balloon body is contracted inward according to the weight of the atmospheric balloon, a second balloon portion of the balloon body coupled with the canopy tethers is expanded outward relative to the first balloon portion according to filling of the canopy, a plurality of filling channels extend along the atmospheric balloon toward the canopy according to the respective contracted and expanded first and second balloon portions, and the canopy tethers suspend the atmospheric balloon from the canopy.

14. The balloon including the descent decelerator of claim 13, wherein each of the canopy tethers of the plurality of canopy tethers include a balloon perimeter coupling that couples the canopy tether to a balloon perimeter and a canopy perimeter coupling that couples the canopy tether to a canopy perimeter,
the balloon perimeter couplings are spaced around the balloon perimeter, and the canopy perimeter couplings are spaced around the canopy perimeter, and
the plurality of canopy tethers are spaced around the canopy perimeter and the balloon perimeter according to the spacings of the balloon perimeter couplings and the canopy perimeter couplings.

15. The balloon including the descent decelerator of claim 14, wherein each of the balloon perimeter couplings of the plurality of canopy tethers are coupled with respective tendons of the atmospheric balloon.

16. The balloon including the descent decelerator of claim 15, wherein the respective tendons include a first set of tendons, and at least some of the tendons of the first set of tendons are interposed with at least some tendons of a second set of tendons.

17. The balloon including the descent decelerator of claim 15, wherein the atmospheric balloon includes a payload coupled beneath the balloon body with the respective tendons, and in the deflated configuration the canopy tethers and the respective tendons coupled with the canopy tethers suspend the payload from the canopy.

18. The balloon including the descent decelerator of claim 13, wherein the canopy is spread along the upper portion of the atmospheric balloon according to spacing of the plurality of canopy tethers around a canopy perimeter and a balloon perimeter.

19. The balloon including the descent decelerator of claim 13, wherein the plurality of filling channels are spaced around a balloon perimeter according to spacing of the plurality of canopy tethers around the balloon perimeter.

20. The balloon including the descent decelerator of claim 13, wherein in the deflation configuration the plurality of canopy tethers coupled around a canopy perimeter and a balloon perimeter centrally suspend the atmospheric balloon below the canopy.

21. The balloon including the descent decelerator of claim 13, wherein the canopy is centrally suspended above the atmospheric balloon by the plurality of canopy tethers coupled around a balloon perimeter and a canopy perimeter.

22. The balloon including the descent decelerator of claim 13 comprising an apex fitting coupled with the upper portion of atmospheric balloon and surrounded by the plurality of canopy tethers, and
in the deflation configuration the apex fitting is positioned within the balloon perimeter.

23. The balloon including the descent decelerator of claim 22, wherein the descent decelerator includes at least one apex suspension line coupling the apex fitting to a canopy inner portion, the apex suspension line suspends the apex fitting near an uppermost portion of the atmospheric balloon in the deflation configuration.

24. The balloon including the descent decelerator of claim 23, wherein the apex fitting includes a deflation port, and the at least one apex suspension line suspends the deflation port near the uppermost portion of the atmospheric balloon in the deflation configuration.

25. A method for decelerating a descending balloon comprising:
deflating an atmospheric balloon to trigger descent;
deploying a descent decelerator including a canopy, the canopy is initially spread along an upper portion of the atmospheric balloon, deploying including:
filling the canopy with atmosphere according to descent of the deflating atmospheric balloon, and
suspending the deflating atmospheric balloon below the filled canopy with the plurality of canopy tethers coupled between a balloon perimeter of the atmospheric balloon and a canopy perimeter of the canopy; and
slowing the descent of the deflating atmospheric balloon with the filled canopy.

26. The method of claim 25, wherein deploying the descent decelerator includes:
contracting a first balloon portion inward according to a weight of the deflating atmospheric balloon,
expanding a second balloon portion outward relative to the contracting first balloon portion according to outward pulling of the canopy tethers by the filling canopy,
forming a plurality of filling channels along the atmospheric balloon according to the respective contracting and expanding of the first and second balloon portions, the filling channels extending toward the canopy, and
filling the canopy includes delivering atmosphere through the filling channels to the canopy according to descent of the deflating atmospheric balloon.

27. The method of claim 25, wherein a deflation port of the atmospheric balloon is coupled with the canopy, and
comprising suspending the deflation port at an uppermost portion of the deflating atmospheric balloon according to deployment of the canopy.

28. The method of claim 27, wherein deflating the atmospheric balloon includes delivering a lift gas through the suspended deflation port according to the suspension of the deflation port at the uppermost portion of the deflating atmospheric balloon.

29. The method of claim 27, wherein the deflation port is included with an apex fitting coupled with the upper portion of the atmospheric balloon and at least one apex suspension line couples the apex fitting with the canopy, and
suspending the deflation port includes suspending the apex fitting with the at least one apex suspension line.

30. The method of claim 25, wherein a central portion of the canopy is coupled with the atmospheric balloon, and filling the canopy with atmosphere includes:
constraining vertical filling of the canopy according to the coupling of the central portion of the canopy with the atmospheric balloon, and
expanding the radius of the canopy from the central portion according to constraint of vertical filling.

31. The method of claim 25, wherein the atmospheric balloon includes a payload coupled below a balloon body with tendons spaced around the balloon body, and the plurality of canopy tethers are coupled with the tendons, and
suspending the deflating atmospheric balloon below the filled canopy includes the plurality of canopy tethers coupled with the tendons suspending the payload from the filled canopy.

32. The method of claim 25, wherein the atmospheric balloon includes a payload coupled below a balloon body, and the payload is suspended from the filled canopy with suspending of the deflating atmospheric balloon from the filled canopy, and
suspending the deflating atmospheric balloon below the filled canopy with the plurality of canopy tethers includes:
forming a tether cage with the canopy tethers surrounding the balloon body, the canopy tethers tensioned between the payload and the canopy, and
stowing the balloon body within the tether cage.

33. The method of claim 25 comprising venting atmosphere from the filled canopy, venting minimizing shock between the canopy and the atmospheric balloon during deploying of the descent decelerator.

34. The method of claim 25, wherein the canopy includes a material at least partially translucent to sunlight, and
comprising passing sunlight through the canopy spread along the upper portion of the atmospheric balloon while the atmospheric balloon is in an inflated configuration.
